(19) United States
(12) Patent Application Publication
(10) Pub. No.: US 2026/0320149 A1
(43) Pub. Date: Oct. 15, 2026

(54) POLYGONAL REDUCTION ALGORITHM FOR NON-LINEAR DATA FORMATS

(71) Applicant: Intel Overseas Funding Corporations, Chandler, AZ (US)

(72) Inventors: Phani Kumar Nyshadham, Bengaluru (IN); Tzachi Cohen, Kochav Yair (IL); Keren Luzon, Tel-Aviv (IL)

(73) Assignee: Intel Overseas Funding Corporations, Chandler, AZ (US)

(21) Appl. No.: 19/467,165

(22) Filed: Feb. 2, 2026

Related U.S. Application Data
(63) Continuation of application No. 17/567,914, filed on Jan. 4, 2022, now abandoned.

(51) Int. Cl. G06F 17/16

(52) U.S. Cl. CPC G06F 17/16

(57) ABSTRACT

A computation system for deep learning applications includes a memory and a processor. The memory is configured to store numerical data at a given stored datatype. The processor includes a processing vector unit and a reduction module. The processing vector unit has a given vector width. The reduction module is configured to reduce a dimension of an input tensor by (i) defining a sequence of elements of the input tensor, which follows a path through the input tensor that is derived from a datatype size of the elements of the input tensor, the given size of the processing vector unit, and the stored datatype, and (ii) forming an output vector by traversing the elements of the input tensor according to the path.

### CROSS-REFERENCE TO RELATED APPLICATION

This application is a continuation of (and claims the benefit of priority to) U.S. patent application Ser. No. 17/567,914, filed Jan. 4, 2022 and titled “POLYGONAL REDUCTION ALGORITHM FOR NON-LINEAR DATA FORMATS,” which is incorporated herein by reference in its entirety for all purposes.

### FIELD OF THE INVENTION

The present invention relates generally to deep learning, and particularly to processing algorithms for running deep learning operations efficiently on different processing architectures.

### BACKGROUND OF THE INVENTION

Methods for data rearrangement to assist deep learning calculations were previously proposed in the patent literature. For example, U.S. Pat. No. 10,489,680 describes efficient implementation of a convolutional layer of a convolutional neural network. In one aspect, weight values of kernels in a kernel stack of a convolutional layer can be reordered into a tile layout with tiles of kernels. Pixel values of input activation maps of the convolutional layer can be reordered into an interleaved layout comprising a plurality of clusters of input activation map pixels. The output activation maps can be determined using the clusters of the input activation map pixels and kernels tile by tile.

### SUMMARY OF THE INVENTION

An embodiment of the present invention that is described hereinafter describes a computation system for deep learning applications, the system including a memory and a processor. The memory is configured to store numerical data at a given stored datatype. The processor includes a processing vector unit and a reduction module. The processing vector unit has a given vector width. The reduction module is configured to reduce a dimension of an input tensor by (i) defining a sequence of elements of the input tensor, which follows a path through the input tensor that is derived from a datatype size of the elements of the input tensor, the given size of the processing vector unit, and the stored datatype, and (ii) forming an output vector by traversing the elements of the input tensor according to the path.

In some embodiments, the reduction module is configured to set the reduction path by performing the steps of:
receiving an interleaved vector of size 1×u*N, wherein u and N are integers, wherein the interleaved vector has u*N elements that are interleaved with a given interleaving factor n, n being a ratio between a size of the given stored datatype of intermediately stored elements and the size of the datatype of the elements of the input tensor;
applying group reduction (GR) to the interleaved vector into a matrix of size n×N by:
reshaping the interleaved vector into n groups of matrix elements, each group being of size p×N, wherein p=ceil(u/n); and
reducing the n groups into n respective vectors of size 1×N and concatenating the n vectors into an interleaved data matrix of size n×N;
if N is a multiple of n, applying fold reduction (FR) to the data matrix, by splitting each row of the data matrix into n parts, reducing all the parts into respective line matrices of size 1×N/n and concatenating the line matrices; and
if N is not a multiple of n, applying polygonal interleaving reduction (PIR) to the interleaved data matrix, by generating for the data matrix a path matrix comprising n reduction paths, reducing n chunks of the interleaved data matrix according to the path matrix, and de-interleaving and converting the n reduced chunks into 1×N result matrix.

In some embodiments, u is a roll factor used in applying reshaping reduction to an M×N matrix into an (M/u)×(u*N) matrix, so as to utilize the processing vector unit using u=floor((the given size of the processing vector unit/N)).

In an embodiment, if u/n is not an integer, reshaping the interleaved vector comprises generating at least one group with dimension p×N by padding Do-Not-Care (DNC) elements.

In another embodiment, the size of the stored datatype is 2^{m} and the datatype size of the elements of the input tensor is 2ⁿ, where m and n are integers and m>n.

In some embodiments, the given size of the processing vector unit is 2^{l}, the dimension of the input tensor is N, wherein l and N are integers and 2^{l}>N.

There is additionally provided, in accordance with another embodiment of the present invention, a computation method for deep learning applications, the method including (a) storing numerical data at a given stored datatype, and (b) using a processor comprising a reduction module and processing vector unit having a given vector width, reducing a dimension of an input tensor with the reduction module by (i) defining a sequence of elements of the input tensor, which follows a path through the input tensor that is derived from a datatype size of the elements of the input tensor, the given size of the processing vector unit, and the stored datatype, and (ii) forming an output vector by traversing the elements of the input tensor according to the path.

The present invention will be more fully understood from the following detailed description of the embodiments thereof, taken together with the drawings in which:

### BRIEF DESCRIPTION OF THE DRAWINGS

FIG. 1 is a schematic, pictorial block diagram of a computation system configured to reduce an input tensor (first reduced by reshaped reduction (e.g., partial reduction) thus utilizing HW vectorization capabilities to the maximum possible extent) using a Group Reduction (GR) algorithm followed by Folded Reduction (FR) and/or Polygonal Interleaving Reduction (PIR) algorithms, in accordance with an embodiment of the present invention;

FIG. 2 is a flow chart that schematically illustrates a method of reducing an input tensor by the computation system through stages involving algorithms of FIG. 1, in accordance with an embodiment of the present invention;

FIG. 3 is a flow chart that schematically illustrates details of the method of completing the interleaved data reduction of FIG. 2 using the PIR algorithm, in accordance with an embodiment of the present invention;

FIG. 4 is a flow chart showing a numerical example following the methods of FIGS. 2 and 3, in accordance with an embodiment of the present invention;

FIG. 5 is a diagram showing a numerical example of the data matrix with the chunks used in FIG. 4 for chunk reduction, in accordance with an embodiment of the present invention; and

FIGS. 6A and 6B are diagrams showing numerical examples of the split matrix and one of the path matrices used in FIG. 4, respectively, in accordance with an embodiment of the present invention.

### DETAILED DESCRIPTION OF EMBODIMENTS

### Overview

In many deep learning applications, reduction over columns of a 2D tensor (also called “summation”) is one of the most important operations, as well as being one of the most frequently used. In many practical scenarios, the dimension M of the axis over which summation is performed is very large, being not the fastest changing dimension (non-FCD), while the FCD N is relatively very small (i.e., M>>N). These characteristics make the reduction operations of deep learning applications ubiquitous, time-consuming, and difficult. Attempts to optimize reduction often encounter both low hardware (HW) utilization and datatypes incompatibility problems that exacerbate difficulties.

In particular, given the small FCD N, performing reduction with a hardware vector dimension much larger than the FCD yields low HW utilization, which exacerbates the challenge of making reductions efficiently. One possible solution to the low HW utilization may be to reshape the tensor (e.g., matrix) by unrolling the matrix to an axis dimension (e.g., line dimension N′) compatible with the HW computing architecture vector size S, N′~S. In this manner, a more fully parallel summation can be performed over all columns at once with higher HW utilization. To this end, the M×N input matrix is reshaped using a so-called unroll factor u=floor(S/N) that generates a reshaped matrix with dimensions (M/u)×(u*N) As seen, u*N is typically very close to S (e.g., within several percent).

However, such a reshaped reduction operation into 1×u*N involves storing intermediate results of the line matrix elements of a given, so-called, “source” datatype (e.g., 8-bit datatype), in a memory that holds intermediate results (after partial reduction) in a higher datatype format (e.g., 64-bit datatype) for accuracy reasons, this storage datatype is so-called hereinafter “destination” datatype. This causes the reshaped-reduced data to be stored in the memory in a nonlinear fashion. In the present context, the term “nonlinear storage of data” means that data values, having respective indices, are stored in an order that is not a monotonic (increasing or decreasing) order of the indices. One non-limiting example of a nonlinear order is an interleaved order of the indices.

More generally, e.g., as an example of pure non-linearity, the proposed algorithm may involve applying a permutation of elements of intermediate matrices, causing the intermediate matrices to be ordered nonlinearly. In subsequent steps the algorithm will include performing de-permutations to finalize calculations.

In the current example, the data is stored interleaved, with an interleaving factor n, which is defined as the ratio between the destination datatype and the source data type. Thus, in general, as a result of the different destination and source datatypes, indices of stored matrix elements run interleaved: [0, n, 2 n . . . , (N−1)n], [Nn, (N+1)n, (N+2)n . . . (2N−1)n], . . . instead of running linearly: [0, 1, 2, 3, . . . , Nn−1].

To finalize the reduction of interleaved data, a next step may be applied, to linearly serialize the stored elements (i.e., rearranging the index in a linearly increasing fashion 0,1,2,3 . . . ). Once the data is serialized linearly, it is unreshaped into the original native matrix FCD, yielding a uXN. Then a conventional non-FCD reduction is performed to produce the final reduced output of the 1×N matrix. However, the linear serialization of data using the loading and storing of memory elements (that occurs within the memory vector register) is a very costly operation. It typically involves numerous data shifts, shuffles, and other ‘mathematical rearrangements.’. The computation cost can easily become prohibitive when working with multi-dimensional tensors with large non-FCDs.

Embodiments of the present invention that are described hereinafter provide methods, algorithms, and programmable software tools that provide a highly efficient reshaping-reduction scheme that overcomes the inefficiency introduced by non-linear (e.g., interleaved) stored data. The disclosed algorithms seamlessly handle linearly stored data of arbitrary dimensions, thereby enabling full and highly efficient tensor reduction whether or not an intermediate step of nonlinearly serialized data storage occurs during reduction.

To solve the nonlinear data storage problem, the disclosed technique utilizes the HW-related interleaving factor n to cover different cases of nonlinear data. In general, given a destination with 2^{m}-bit datatype and source with 2ⁿ-bit datatype, with m>n, n=2^{(m-n)}, the interleaving factor n can take the values of 2, 4,8, 16 (and so on). For example, in case of a destination 64-bit floating storage datatype, m=6, source and 4-bit floating matrix elements, n=2 datatype, n equals 16. The interleaving factor is set to be a trivial n=1 for linearly stored data.

The disclosed algorithms take into account the aforementioned FCD N and the interleaving factor n, as described hereinafter, to perform an efficient reduction.

In some embodiments, to solve the problem of reducing non-linear data after a partial reduction, the disclosed technique includes the following steps:

Running a Group Reduction (GR) algorithm that unreshapes the line data into n groups (e.g., where each group of data forms a matrix, and performs reduction on each individual group and concatenates the outputs into a n×N so-called data matrix). The data matrix is already much more compact than the original matrix, and it remains to reduce its n lines into one, however, each line has scrambled data, which requires the algorithms described below to complete the reduction.

When N is a multiple of n, running an algorithm called hereinafter Folded Reduction (FR), to perform full reduction of the data matrix into the required 1×N line matrix.

When N is not a multiple of n, the data matrix is still “scrambled,” having matrix elements mixed (or “hopped”) between columns and rows in a way that hinders further reduction. Noting that the elements hop according to a mathematical rule enables sorting the elements such that reduction can take place. Sorting the data matrix requires employing an algorithm called a Polygonal Interleaved Reduction (PIR) that efficiently completes the full reduction of the data matrix into the required 1×N line matrix.

The disclosed technique, and in particular the PIR algorithm, is useful for parallel computing, i.e., the parallel use of multiple computer resources. For example, the disclosed technique is most suitable for single instruction, multiple data (SIMD) parallel computing architectures. A SIMD system is a multiprocessor machine capable of executing the same instruction on all of its processors but operating on different data streams. Machines based on a SIMD model are well suited to perform vector and matrix operations, such as matrix multiplication (MM). In particular, organized data elements of vectors can be divided into multiple sets to be separately processed.

### System Description

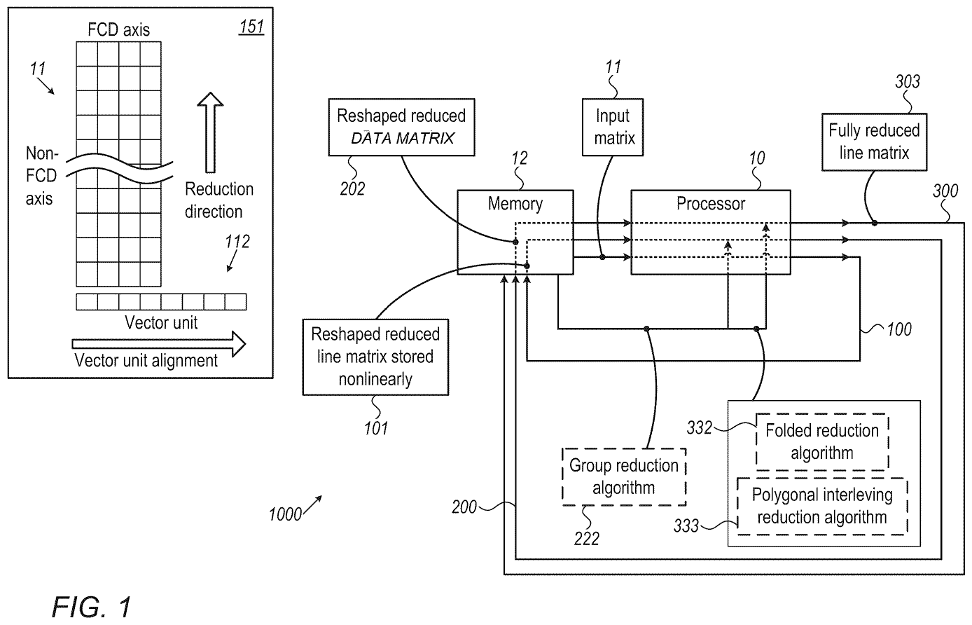

FIG. 1 is a schematic, pictorial block diagram of a computation system 1000 configured to reduce an input matrix (after partial reduction) using Group Reduction (GR) algorithm 222 followed by Folded Reduction (FR) 332 and/or Polygonal Interleaving Reduction (PIR) algorithms 333, in accordance with an embodiment of the present invention.

In the shown embodiment, a processor 10 of system 1000 reshape-reduces (step 100) an input matrix 11 having dimensions M×N, M>>N, N being the FCD axis dimension. Matrix 11 is illustrated in inset 151 as an N=4 column matrix. As further seen therein, processor 10 has a vector unit 112 to which matrix 11 can be reduced that is illustrated as 8 elements wide. This would cause a 50% HW utilization during a straightforward reduction of matrix 11 into a 1×N vector.

Therefore, in an intermediate step, matrix 11 is reshape-reduced into a line matrix (i.e., vector) 101 that is, however, nonlinearly (e.g., interleaved) stored in a memory 12. The issue of interleaving arises when memory 12 is assumed to have a given datatype (destination data type) different from the datatype of the matrix 11 elements. For example, memory 12 datatype is a 2^{m}-bit floating point or 2^{m}-bit integer, whereas Elements of matrix 11 are assumed to be in another given, lower, datatype (source data type), such as a 2ⁿ-bit floating point or integer respectively, m>n, causing the above interleaving.

In one embodiment, memory 12 further stores the disclosed GR algorithm 222, as well as other algorithms that facilitate the reduction of matrix 11 into the fully reduced line matrix 303. In some embodiments, the FR and PIR algorithms 332 and 333, respectively, are implemented using dedicated HW modules or SW modules on ASICs or general-purpose processors.

The GR algorithm is employed in step 200 to reshape-reduce vector 101 into a so-called data matrix 202, described below. The FR and/or PIR algorithm are employed in step 300, as further described below, to reduce data matrix 202 into line matrix 303 of dimensions 1×N that is the required final output.

FIG. 1 is brought by way of example and for the purpose of clarifying the concepts. For example, in other embodiments, system 1000 receives the nonlinearly serialized (e.g., interleaved) vector 101, so step 100 is not performed by the system, skipping directly to step 200.

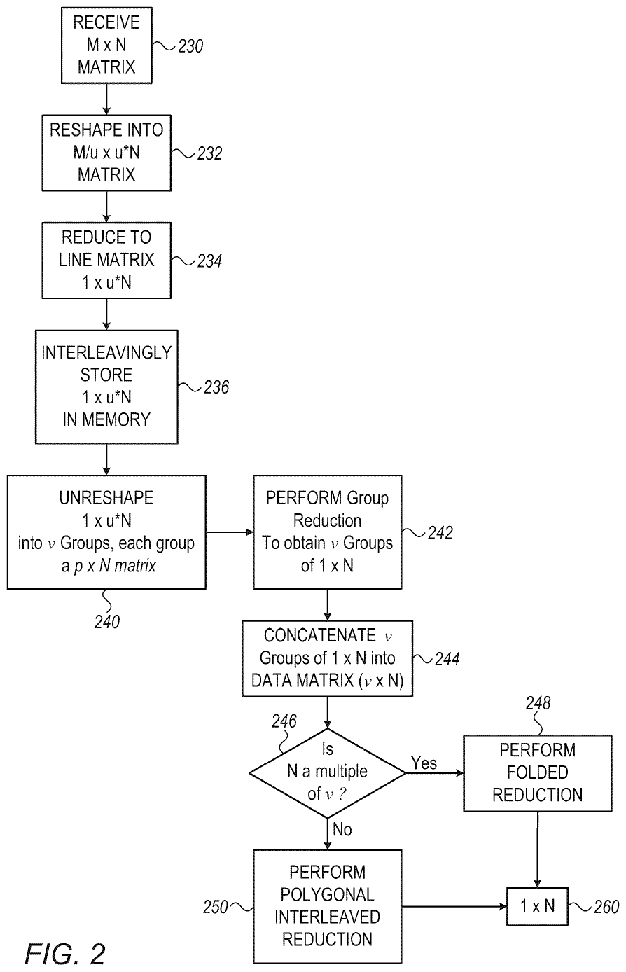

In various embodiments, the different elements of the computation system shown in FIG. 1 may be implemented using suitable hardware, such as using one or more discrete components, one or more Application-Specific Integrated Circuits (ASICs) and/or one or more Field-Programmable Gate Arrays (FPGAs). Some of the functions of the disclosed computation system, e.g., some or all functions of the processor, may be implemented in one or more general-purpose processors, which are programmed in software to carry out the functions described herein. The software may be downloaded to the processors in electronic form, over a network or from a host, for example, or it may, alternatively or additionally, be provided and/or stored on non-transitory tangible media, such as magnetic, optical, or electronic memory. In particular, computation system 1000 runs a dedicated algorithm as disclosed herein, including in FIG. 2, that enables computation system 1000 to perform the disclosed steps, as further described below.

### GR, FR, and PIR Reduction Algorithms for Non-Linear Data Formats

FIG. 2 is a flow chart that schematically illustrates a method of reducing an input tensor end-to-end involving interleaved data storage of intermediate results after partial reduction, by computation system 1000 and algorithms 222, 332, and 333 of FIG. 1 in accordance with an embodiment of the present invention. The method employs the GR algorithm 222 to perform part of the non-FCD reduction. Subsequently, the FR and/or PIR algorithms 332 and 333 in computation system 1000 completes the reduction. The process begins at an input matrix receiving step 230, with processor 10 receiving an M×N matrix with N being the FCD and N<<M.

Next, at a matrix reshaping step 232, processor 10 reshapes the M×N into an (M/u)×(u*N) matrix, using an unroll factor u calculated as a rounded-down ratio of the processing HW vector processing architecture dimension (e.g., HW vectorization width) (e.g., having a size S of a processing unit vector being, S=2^{l}, l being integer, such as, S=512, S=1024) over the non-FCD dimension. The reshaping generates a dimension u*N which is very close to the processing architecture dimension, yielding a very high HW utilization in a subsequent reduction step 234 to a line matrix 1×(u*N).

Processor 10 stores the data in line matrix 1×(u*N) in memory 12 at an interleaving storage step 236. The reason interleaving occurs is that the stored datatype in memory is typically larger than the datatype in the matrix elements (e.g., 32-bit vs 4-bit in the example given above).

A first next step to handle the interleaved data is to unreshape (step 240) line matrix 1×u*N into groups, which are typically matrices of certain dimensions that make it proper for the disclosed GR algorithm and for subsequent FR and/or PIR algorithms. Unreshaping the data stored in the above format in memory is done into p×N matrices, each of which called a group. The unreshaping is performed on each of the distinct arrays [0, n, 2 n . . . , (N−1)n], [Nn, (N+1)n, (N+2)n . . . (2N−1)n], . . . independently to form n groups, where a group is defined by:
Every group contains (u*N)/n elements
In a group, the (u*N)/n elements are divided into lines of N to get ‘p’ lines per group, where p=ceil((u*N)/(n*N))
If some lines in a group are partially filled (which can happen when u/n is not an integer) the processor fills the rest of the line with DNC (DO NOT CARE for summation)=0.

At a reduction step 242, the disclosed GR algorithm reduces each of the n groups (each group containing p×N) into n groups of 1×N line matrix.

At data concatenating step 244, processor 10 concatenates the number n of 1×N line matrices to produce a n×N shown in FIG. 1 as a data matrix 202. Data matrix 202 is the starting point for FR and/or PIR algorithms.

In a checking step 246, the processor checks if N is a multiple of n. If the answer is yes, the processor invokes the FR algorithm to perform Folded Reduction (248) of the data matrix.

Folded Reduction splits every row of the data matrix into n parts and folds the parts. In this way, the data matrix is split into n parts, and the processor reduces all of the n parts to produce N/n elements per row (e.g., the data matrix is cut into n parts horizontally and the parts are all folded onto each other and reduced into n×N/n matrix which is de-interleaved and converted back into 1×N result). For example, if N is even and n=2, the missing indices falls in the same row. Hence, the processor divides the data matrix into left and right halves and fold-reduces the halves one onto the other. In this way, every row is split into a left half and a right half. Both of the half-rows are fold-reduced into a half-row, which is performed for all the rows. All the rows are interspersed into a single row which is the final reduced matrix 1×N (260).

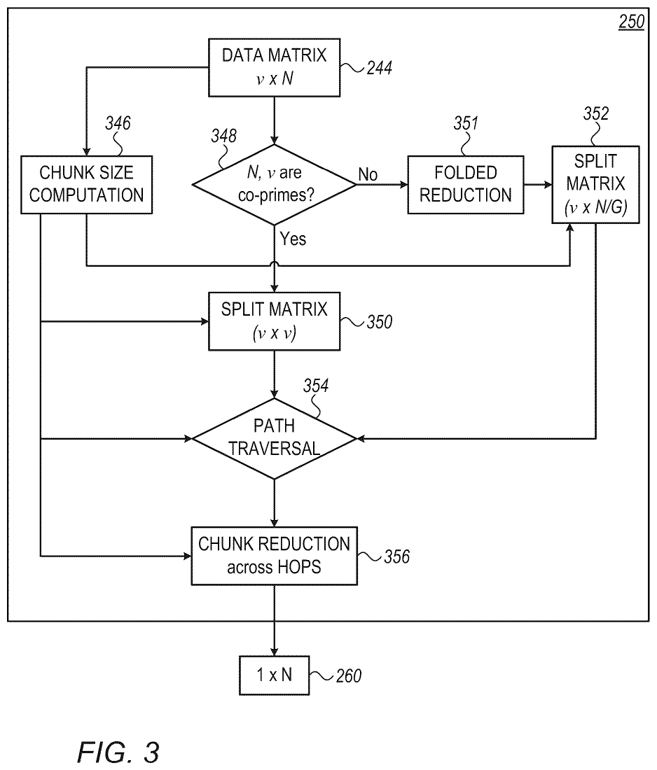

If N is not a multiple of n, the processor invokes the PIR algorithm to perform polygonal reduction (250) of the data matrix into the reduced matrix 1×N (260), as described in FIG. 3.

FIG. 3 is a flow chart that schematically illustrates details of the method of completing the interleaved data reduction of FIG. 2 using the PIR algorithm 333, in accordance with an embodiment of the present invention. The method utilizes the aforementioned FR and/or PIR algorithm to complete the non-FCD reduction started by the GR algorithm described in FIG. 2. The process begins at a data matrix 244 receiving step 344, with processor 10 receiving the n×N data matrix that is the output of the GR algorithm.

Recalling that the data matrix has n*N elements, the final target is to produce N elements out of this matrix, though, as noted above, identification of the missing samples/indices, occurring when N is not multiple of n, for reduction, is the crux of the problem solved herein.

Next, to this end, at a chunk-matrix size computing step 346, processor 10 calculates an element-clustering measure called chunk size, which defines the degree ofvectorization of the proposed polygonal reduction algorithm for processing architecture, such as for SIMD architectures. The chunk size is defined for every row of the data matrix. Not all the chunks have the same chunk size. There is a threshold row from which the chunk size is one element smaller than the size for the chunk in the first row. The chunk size and threshold on rows is computed as follows:

$${th}_{row} = N mod v ; {th}_{row} \leq v - 1$$

$${x}_{first} = floor ( \frac{N - 1}{v} ) + 1 ; 0 \leq row < {th}_{row}$$

$${x}_{second} = {x}_{first} - 1 ; row \geq {th}_{row}$$

Putting together the above equations is shown below:

$${x}_{first} = floor ( \frac{N - 1}{v} ) + 1 ; 0 \leq row < {th}_{row}$$

$${x}_{second} = floor ( \frac{N - 1}{v} ) ; row \geq {th}_{row}$$

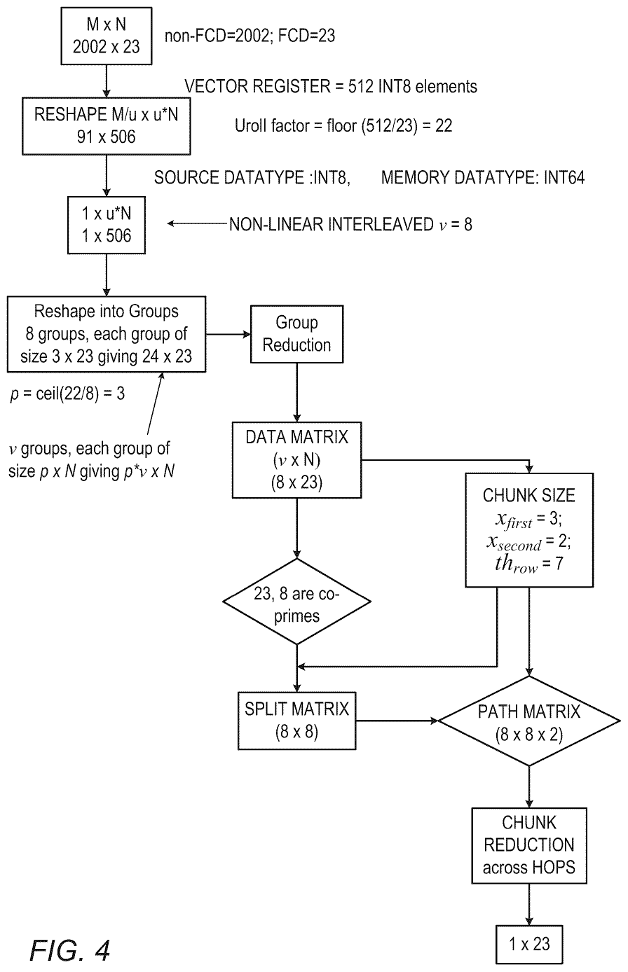

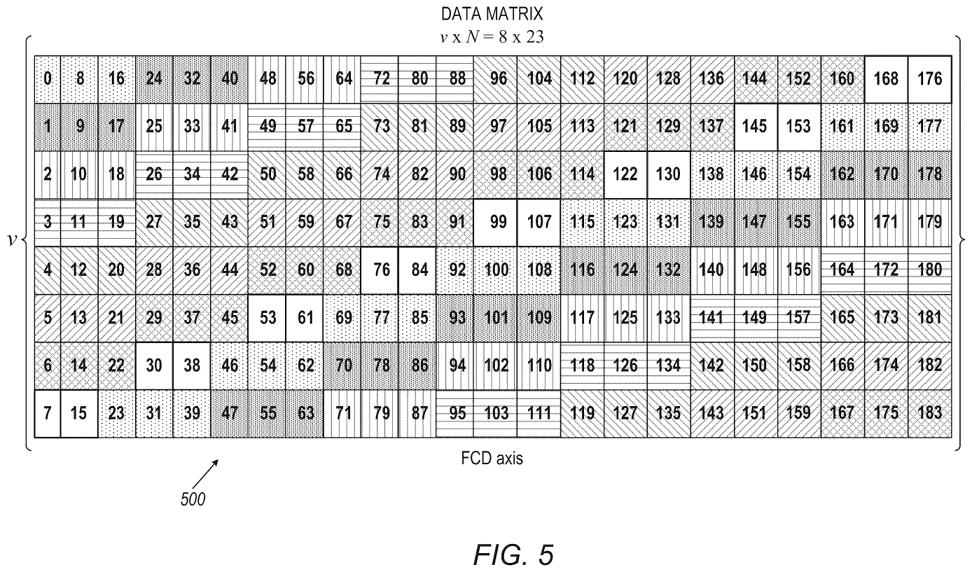

Note that FIGS. 4 and 5 show a concrete numerical example that clarifies this calculation as well as other calculations included in the GR, FR and PIR algorithms.

If n and N are co-primes (i.e., don't share any common divisor but 1), as checked in step 348, processor 10 employs the PIR algorithm to construct (step 350) a split matrix of dimension n×n of the chunks, such that, based on the property that every row of the data matrix comprises all or subset of chunks in full, the split matrix defines the position of chunks (i.e., sub-matrices of the data matrix) in every row of the split matrix according to a linearized enumeration of the chunks.

The construction of the split matrix follows these steps:

Computing the specific row and column occupied by a chunk for every hop. As every chunk is a continuous string of elements, the processor computes the row and column occupancy for the start-index/sample of the chunk for every hop.

For example, if a start-index/sample of chunk ‘y’ for a hop ‘h’ occupies r^{th} row and c^{th} column, this means

r+cv=y+hN;0≤y≤v−1

By careful observation, we can compute r and c as shown below:

$$c = \frac{( y + hN )}{v} ; 0 \leq y \leq v - 1$$

$$r = ( y + hN ) mod v ; 0 \leq y \leq v - 1$$

Once processor 10 computes the row and column occupancy of every chunk for every hop, the processor recursively constructs the split matrix of dimension n×n such that it satisfies the constraints described below:

The (r, c) pair for a chunk for a hop should always start at the column right after the completion of one/more chunks other than the chunk under consideration. This should be true for every row and every chunk and every hop of that chunk

$${c}_{j , r} = {\sum }_{{i}_{r} = 1}^{{k}_{j , r} \leq v - 1} {chunkSize}_{{i}_{r}} ; 0 \leq {c}_{j , r} \leq C - 1 ;$$

$${chunkSize}_{1} = {x}_{first} 0 \leq r < {th}_{row}$$

$${chunkSize}_{1} = {x}_{second} ; r \geq {th}_{row}$$

where C is the number of columns of the split matrix, and where c_{j,r} is the column occupancy of the j^{th} chunk in r^{th} row such that 0≤j≤v−1, and where k_{j,r} is the number of already occupied chunks in r^{th} row from the start, where chunkSizeᵢ_{ᵣ} is the iᵣ^{th} chunk in r^{th} row already occupied from the start.

On solving the above equation, we define the location of j^{th} chunk in r^{th} row (l_{j,r}) as

l_{j,r}=k_{j,r;0}≤j≤v−1,0≤r≤v−1

These locations define the split matrix of dimension n×n such that

splitMatrix(r, l_{j,r})=j; 0≤r≤v−1, 0≤l_{j,r}≤v−1

A numerical example of a split matrix for a data matrix is given in FIG. 5. In that example, the split matrix is shown containing chunks filling the matrix. Each chunk is uniquely coded or enumerated (e.g., with an index) to show their occurrences across rows.

If n and N are not co-primes, i.e., if N and n have a common factor, every chunk hops across a subset of rows. In such a case, the aforementioned folded reduction step 351 precedes the PIR algorithm.

After folded reduction, the processor generates a folded-reduced split matrix of dimensions

$$v \times \frac{N}{GCD ( N , v )} . ,$$

where GCD(N,v), also called G, is the greatest common divisor of N and n. The chunks are divided into sets, every chunk in a set hopping across the rows within that set. For example, when N and n are even, even chunks hop across even rows. Odd chunks always hop across odd rows.

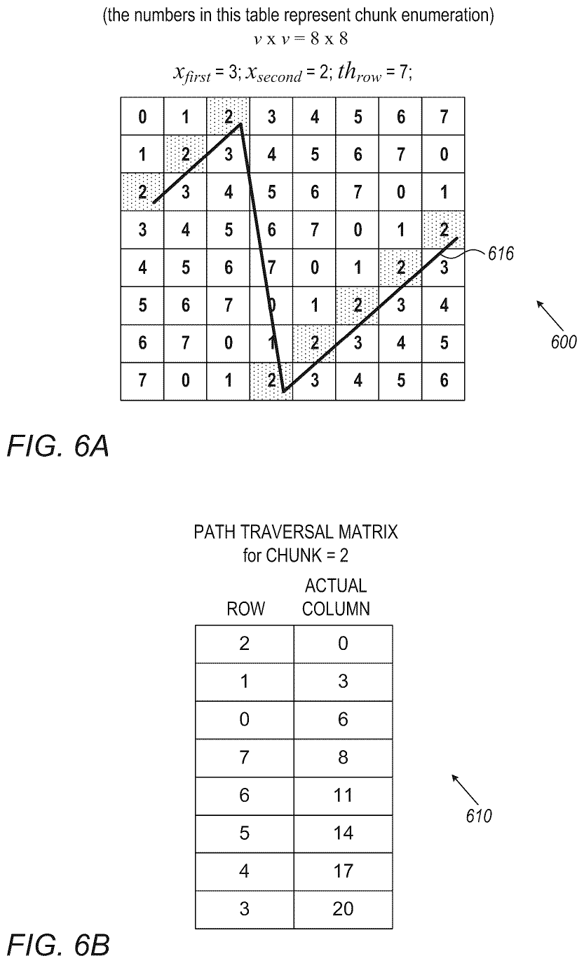

Next, processor 10 constructs (step 354) a path matrix also called a chunk path traversal matrix. This path matrix is constructed from the split matrix from any of its two variants described above, where the path of every chunk is tracked and cached into a look up table or memory. In FIG. 6B, a path traversal example refers to the path of a specific-indexed rectangle (shown in FIG. 6A) while traversing across columns from left to right.

The path matrix is instrumental in identifying the chunks of the same index in the split matrix and reducing them sequentially to get the final desired reduction output.

The path matrix is a 3D matrix of dimensions n×n×2. The first dimension in the path matrix refers to the chunk enumeration. The second dimension in the path matrix refers to the rows of the split matrix. The third dimension stores the (x, y) coordinates of the traversing chunk inside the data matrix across each hop. The (x, y) coordinates for a chunk inside a row are achieved as cumulative addition of the chunk sizes precedes this chunk inside the split matrix. In FIG. 6A below, each index (e.g., integer) represents a chunk. X-axis represents the x-coordinate of the chunk traversed across hops. Y-axis represents the y-coordinate of the chunk traversed across hops.

Finally, at chunks reduction step 356, for every chunk, summation happens across hops (e.g., over path 505 for chunk 2) to get the final reduced chunk. (The chunks cycle through all the rows in this way because N and v are co-primes. There is no need of any FR algorithm preceding the PIR). The processor de-interleaves all the final reduced chunks linearly to produce the fully reduced vector 1×N.

### Performing Polygonal Interleaved Reduction (PIR) Using Matrix Multiplication (MM)

While the path matrix and chunk sizes are computed as mentioned above, the PIR algorithm can also be designed to deploy a Matrix Multiplication (MM) scheme. To produce the reduction result, the processor can perform computations using MM of blocks in batches, as described below.

For every chunk, every row/hop is processed one at a time (called a “batch”). To this end, for every row, the processor constructs a Multiplier Matrix of size N×x_{first} by running the step below:

Filling an N×x_{first} matrix with zeroes.

For extracting j\hat{ }th chunk in r\hat{ }th row, i.e., for j^{th} chunk, extracting the (x, y) coordinates of the chunk in r^{th} row, from the aforementioned path traversal matrix as follows:

Note that there can be more than one occurrence of j^{th} chunk in r^{th} row:
colϵ{pathTraversal(j,r, 2)} such that
   such that
multiplierMatrixᵣ(col+1: col+chunkSize(j),1: chunkSize(j))
   =IDENTITYchunkSize(j)
multiplierMatrixᵣ(p, q)
   =0; (p<col+1)∩(p>col+chunkSize(j))∩(q
   >chunkSize(j))
      where ‘r’ represents a row/hop and 1≤r≤v.

In the steps above, the processor constructs the aforementioned multiplier matrix for this row and performs matrix multiplication (row of data matrix, multiplier matrix), stacks the result inside a Partial-Reduced matrix. To perform the required reduction of every chunk, the processor finds the chunk size, and for every row identifies, from the path matrix, the chunk position (x, y) in this row, as described above.

The computation of the final reduced j^{th} chunk is computed by block MM as follows:
reducedChunkⱼ=MM(oneVector, stackPartialReduction); 1≤j≤v
   where,
stackPartialReduction(r,:)=MM(data(r,:),multiplierMatrixᵣ)
   where oneVector is a vector of ones of size 1×v
   where MM refers to the matrix multiplication operation.

In the computation above, the processor operation Matrix Multiplication (OneVector, Partial-Reduced matrix) produces the final reduced chunk across hops. The processor iterates across chunks and de-interleaves all the final reduced chunks linearly to produce the reduced vector of 1×N.

Further to the description given in FIGS. 2 and 3, and as noted above, the proposed algorithm may involve applying permutation of elements of intermediate matrices that cause the intermediate matrices to be ordered nonlinearly. For example, once the split matrix comprising chunks is carved out, any permutation can be applied to the chunk matrix. After this permutation, the matrix becomes very non-linearly indexed. Once de-permutation is later performed, the algorithm proceeds to produce required reduction.

### Numerical Example of Reduction Using the GR, and FR and/or PIR Algorithms

This section follows a numerical example of the challenges and discloses solutions in reducing a matrix of M×N=2002×23 elements into a 1×23 matrix. Assuming given hardware vector unit's width of 2048 bits (=512 INT4 elements), straight-away reduction of the FCD=23 matrix suffers from severe under vectorization (only 23 columns are utilized for the parallel reduction computation out of the 512 possible, yielding low HW utilization rate of 23/512≈0.045).

As discussed above, one possible solution to the low HW utilization may be to reshape the 2002×23 with the unroll factor u=floor (512/23)=22. The reshaped matrix has dimensions (M/u)×(u*N)=91×506. This matrix is then very efficiently reduced to 1×(u*N)=1×506 (with HW utilization rate of 506/512≈0.99).

The next step involves unreshaping the 1×(u*N) (e.g., 1×506) vector into a uXN (e.g., 22×23) matrix, and subsequently reducing the u×N (e.g., 22×23) matrix to the required 1×N (e.g., 1×23) vector.

However, assuming, by way of example, matrix element datatype of INT4 (e.g., n=2), and storage datatype of INT32 (e.g., m=5), storing intermediate INT4 outputs into 32-bit memory causes the samples to be interleaved by the interleaving factor n=8. As noted above, linearly serializing the interleaved stored data, a step without which unreshaping the data to the required 22×23 matrix cannot be made, is a very costly proposition that renders the full reduction process to a 1×23 matrix which is still inefficient even after all the effort described above.

FIG. 4 is a flow chart showing following the methods of FIGS. 2 and 3, in accordance with an embodiment of the present invention. FIG. 4 follows an example of a disclosed embodiment in which a M×N=2002×23 matrix is reduced to 1×N=1×23 line matrix.

The DTYPE of the M×N matrix is chosen to be 8-bit INT (assumed that the DTYPE is supported). While performing reduction (summation), the intermediate results are intended to be stored in 64-bit INT memory architecture. While storing the 64-bit intermediate outputs into memory, processor 10 interleaves samples by the interleaving factor n=64/8=8.

Considering SIMD register width as 2048 bits=512 INT4 elements, FCD=23, results are in severe under-vectorization for straight-away reduction. Hence, the processor performs matrix reshaping with an unroll factor u=512/23=22. The output of the reshaping step is a matrix (M/u)×(u*N)=91×506. The processor then reduces this matrix to 1×506 matrix.

It is at this point where the samples of the reshaped reduced 1×506 matrix get interleaved by a factor of n=8. At this step the processor invokes the GR algorithm to reshape the reduced matrix into a 24×23 matrix and reduce the 24×23 matrix into the data matrix of size n×N=8×23 (shown indexed in FIG. 5). As N=23 is not a multiple of n=8, processor 10 proceeds with the PIR algorithm as follows:

Based on the calculated chunk sizes, and the path matrix for every chunk of the data matrix (see example of path matrix in FIG. 6B), the row (y-coordinate) and the column (x-coordinate) of the chunk in the next hop is calculated and cumulatively reduced by the processor to get the final reduced chunk. Finally, after all chunks are reduced, the reduced chunks are de-interleaved and converted back to the source datatype to produce 1×N=1×23 matrix which is the result in INT8 DTYPE.

This algorithm can be performed using either Matrix Multiplication or SIMD vectorization.

FIG. 5 is a diagram showing a numerical example of the data matrix 500 with the chunks used FIG. 4 for chunk reduction, in accordance with an embodiment of the present invention. Data matrix 500 is shown encoded with the different chunks that hop from row to row and from column to column. In data matrix 500 there are 8 chunks, 7 of size 3 and 1 of size 2. The rule by which a chunk hops (e.g., chunk 2) is captured by its respective path matrix (see FIG. 6B).

FIGS. 6A and 6B are diagrams showing numerical examples of the split matrix 610 and one (610) of the path matrices used FIG. 4, respectively, in accordance with an embodiment of the present invention. As seen in FIG. 6A, split matrix 610 summarizes the paths taken by the chunks, i.e., over which each of chunks 0-7 reduction should be performed. A path 616 is drawn for chunk 2. The chunk 2 path matrix 610 provides the (row, column) coordinate of the first element in the data matrix of each hoping chunk 2.

Although the embodiments described herein mainly address algorithms for deep learning applications, the methods and systems described herein can also be used in other applications, such as in high-Performance computing and scientific applications. The disclosed technique can be applied, mutatis mutandis, to other variants of reduction. For example, reducing by finding an extremum can be performed by the algorithmic methodology discussed above. Only difference is the DNCs should be properly tuned for the reduction variant. In the case of summation, DNC is set above as 0—in the case of maximum (a variant of reduction where an algorithm finds the maximum of the elements in each column of a 2D matrix), DNC should be set as −Inf.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. One or more non-transitory computer-readable media storing instructions executable to perform operations for performing a deep learning operation, the operations comprising:
reshaping an input matrix of the deep learning operation to form a reshaped input matrix, the reshaped input matrix comprising same input activations as the input matrix and having a different shape from the input matrix, wherein the different shape is determined based on a bit width of a register associated with one or more processing units, the bit width indicating a number of bits to be stored in a register at a time;
performing, by the one or more processing units, reduction computations on the reshaped input matrix to compute a reduced matrix, wherein the reduction computations are performed on different columns of the reshaped input matrix in parallel;
reshaping the reduced matrix to form an intermediate matrix, the intermediate matrix having same activations as the reduced matrix and a different shape from the reduced matrix; and
generating an output matrix of the deep learning operation from the intermediate matrix, wherein generating the output matrix comprises performing, by the one or more processing units, reduction computations on the intermediate matrix.

2. The one or more non-transitory computer-readable media of claim 1, wherein a reduction computation comprises summation over column.

3. The one or more non-transitory computer-readable media of claim 1, wherein the output matrix has a single row and a same number of columns as the input matrix.

4. The one or more non-transitory computer-readable media of claim 1, wherein the shape of the reshaped input matrix is determined further based on a data precision of the input matrix, wherein the output matrix has a different data precision from the input matrix.

5. The one or more non-transitory computer-readable media of claim 1, wherein utilization of the one or more processing units for performing the computations on the reshaped input matrix is higher than utilization of the one or more processing units for performing the computations on the input matrix.

6. The one or more non-transitory computer-readable media of claim 1, wherein the reshaped input matrix has more columns than the input matrix.

7. The one or more non-transitory computer-readable media of claim 1, wherein a reduced intermediate matrix is produced from performing the additional computations in the deep learning operation on the intermediate matrix, wherein generating the output matrix further comprises:
grouping activations of the reduced intermediate matrix into chunks, each chunk comprising a different subset of the activations of the reduced intermediate matrix, wherein activations within a chunk are separated by one or more activations of another chunk; and
converting the reduced intermediate matrix to the output matrix by performing reduction computations on the chunks.

8. The one or more non-transitory computer-readable media of claim 7, wherein a single activation within the output matrix is computed by performing a reduction computation on a single chunk of the reduced intermediate matrix.

9. The one or more non-transitory computer-readable media of claim 7, wherein a dimension of the reduced intermediate matrix is determined based on a bit width of a memory for storing the reduced matrix or the reduced intermediate matrix.

10. The one or more non-transitory computer-readable media of claim 9, wherein a dimension of the reduced intermediate matrix is determined further based on a data precision of the input matrix.

11. A method for performing a deep learning operation, the method comprising:
reshaping an input matrix of the deep learning operation to form a reshaped input matrix, the reshaped input matrix comprising same input activations as the input matrix and having a different shape from the input matrix, wherein the different shape is determined based on a bit width of a register associated with one or more processing units, the bit width indicating a number of bits to be stored in a register at a time;
performing, by the one or more processing units, reduction computations on the reshaped input matrix to compute a reduced matrix, wherein the reduction computations are performed on different columns of the reshaped input matrix in parallel;
reshaping the reduced matrix to form an intermediate matrix, the intermediate matrix having same activations as the reduced matrix and a different shape from the reduced matrix; and
generating an output matrix of the deep learning operation from the intermediate matrix, wherein generating the output matrix comprises performing, by the one or more processing units, reduction computations on the intermediate matrix.

12. The method of claim 11, wherein a reduction computation comprises summation over column, wherein the output matrix has a single row and a same number of columns as the input matrix.

13. The method of claim 11, wherein the shape of the reshaped input matrix is determined further based on a data precision of the input matrix, wherein the output matrix has a different data precision from the input matrix.

14. The method of claim 11, wherein utilization of the one or more processing units for performing the computations on the reshaped input matrix is higher than utilization of the one or more processing units for performing the computations on the input matrix.

15. The method of claim 11, wherein a reduced intermediate matrix is produced from performing the additional computations in the deep learning operation on the intermediate matrix, wherein generating the output matrix further comprises:
grouping activations of the reduced intermediate matrix into chunks, each chunk comprising a different subset of the activations of the reduced intermediate matrix, wherein activations within a chunk are separated by one or more activations of another chunk; and
converting the reduced intermediate matrix to the output matrix by performing reduction computations on the chunks.

16. The method of claim 15, wherein a single activation within the output matrix is computed by performing a reduction computation on a single chunk of the reduced intermediate matrix.

17. The method of claim 15, wherein a dimension of the reduced intermediate matrix is determined based on a bit width of a memory for storing the reduced matrix or the reduced intermediate matrix and a data precision of the input matrix.

18. An apparatus, comprising:
a computer processor for executing computer program instructions; and
a non-transitory computer-readable memory storing computer program instructions executable by the computer processor to perform operations for performing a deep learning operation, the operations comprising:
reshaping an input matrix of the deep learning operation to form a reshaped input matrix, the reshaped input matrix comprising same input activations as the input matrix and having a different shape from the input matrix, wherein the different shape is determined based on a bit width of a register associated with one or more processing units, the bit width indicating a number of bits to be stored in a register at a time,
performing, by the one or more processing units, reduction computations on the reshaped input matrix to compute a reduced matrix, wherein the reduction computations are performed on different columns of the reshaped input matrix in parallel,
reshaping the reduced matrix to form an intermediate matrix, the intermediate matrix having same activations as the reduced matrix and a different shape from the reduced matrix, and
generating an output matrix of the deep learning operation from the intermediate matrix, wherein generating the output matrix comprises performing, by the one or more processing units, reduction computations on the intermediate matrix.

19. The apparatus of claim 18, wherein utilization of the one or more processing units for performing the computations on the reshaped input matrix is higher than utilization of the one or more processing units for performing the computations on the input matrix.

20. The apparatus of claim 18, wherein a reduced intermediate matrix is produced from performing the additional computations in the deep learning operation on the intermediate matrix, wherein generating the output matrix further comprises:
grouping activations of the reduced intermediate matrix into chunks, each chunk comprising a different subset of the activations of the reduced intermediate matrix, wherein activations within a chunk are separated by one or more activations of another chunk; and
converting the reduced intermediate matrix to the output matrix by performing reduction computations on the chunks.
